(19) United States
(12) Patent Application Publication
(10) Pub. No.: US 2012/0212422 A1
(43) Pub. Date: Aug. 23, 2012

(54) Software Aided Physical Keyboard for a Touch-Screen

(75) Inventor: Ta-Chang Fang, Taipei City (TW)

(73) Assignee: iaSolution Inc., Taipei (TW)

(21) Appl. No.: 13/031,253

(22) Filed: Feb. 21, 2011

(51) Int. Cl. G06F 3/041

(52) U.S. Cl. 345/173

(57) ABSTRACT

An electronic device may include a touch-screen for receiving user input, a processor coupled to the touch-screen, a removable flexible material contacting the touch-screen, the flexible material having a plurality of key structures that modify a first touch applied by a user to a key structure of the plurality of key structures into a different, second touch applied to the touch-screen to generate a touch event, and a memory coupled to the processor and including computer code which when executed by the processor interprets the touch event generated by the second touch according to the first touch. A key structure may include physical structures that allow the user using the sense of touch alone to distinguish a key structure.

### BACKGROUND OF THE INVENTION

1. Field of the Invention

This application relates to an electronic device having a touch-screen that utilizes a removable flexible material that modifies a first touch applied by a user into a different, second touch applied to the touch-screen to generate a touch event.

2. Description of the Prior Art

Many newer portable electronic devices employ a touch-screen for receiving user input. However text entry (typing) or even entering a phone number on a touch-screen is relatively awkward using an on-screen virtual keyboard. For accuracy of finger triggered touch locations, it is always easy to trigger the wrong key due to lack of physical guidance and feedback and hence requires some software logic to auto correct the input base on vocabulary heuristics.

Some manufacturers have included a form of haptic technology in their touch-screen devices as a result, such as imparting forces, vibrations, or motions to the user in response to touching of the touch-screen by the user. Because haptic feedback commonly occurs only after the touch is made, the resulting feedback unfortunately only aids in recognition and correction of typing errors, rather than aiding a user in avoiding them in the first place. A straight forward solution offered today is to add a conventional physical hardware QWERTY or ITU-9 keyboard that slides out from under the device's housing or is attached to the device's housing adjacent to the device's touch-screen; however inclusion of a conventional physical hardware keyboard necessarily leads to more weight, size, cost, and mechanical complexity.

### SUMMARY OF THE INVENTION

An electronic device may include a touch-screen for receiving user input, a processor coupled to the touch-screen, a removable transparent or semi-transparent flexible material contacting the touch-screen, the flexible material having a plurality of key structures that modify a first touch applied by a user to a key structure of the plurality of key structures into a different, second touch applied to the touch-screen to generate a touch event, and a memory coupled to the processor and having computer code which when executed by the processor interprets the touch event generated by the second touch according to the first touch. The computer code may further include calibration code for calibrating location of the flexible material in relation to the touch-screen.

According to some embodiments, a key structure of the plurality of key structures may include a bump or series of bumps, one or more ridges, and/or one or more depressions formed on, or extending from, one or both sides of the flexible material that allow the user using the sense of touch alone to distinguish if a specific area of the flexible material is the key structure or another area of the flexible material that is not the key structure. The flexible material may include a Radio Frequency Identification chip or a Near Field Communications chip to identify the flexible material to the electronic device. The area of the flexible material that is not the key structure may separate the specific area of the flexible material that is the key structure from contact with the touch-screen when the key structure is not being pressed by the user.

According to some embodiments, the plurality of key structures are formed such that at least two of the key structures have different physical structures allowing accurate selection of a specific key structure by touch alone, and/or the key structure may include a visual marking indicating which character or function is to be associated with that particular key, and/or the key structures may further include a conductive material.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an electronic device that utilizes a touch-screen for receiving user input.

FIG. 2 is an Input Assist Pad according to an embodiment of the disclosure.

FIG. 3 illustrates an end view of an electronic device as seen from the end of the electronic device nearest the Input Assistant Pad of FIG. 2 according to an embodiment of the disclosure.

FIG. 4 illustrates an end view of an electronic device as seen from the end of the electronic device nearest the Input Assistant Pad of FIG. 2 according to an embodiment of the disclosure.

FIG. 5 illustrates an end view of an electronic device as seen from the end of the electronic device nearest the Input Assistant Pad of FIG. 2 according to an embodiment of the disclosure.

FIG. 6 is a partial functional block diagram of inside of an electronic device that utilizes a touch-screen for receiving user input according to an embodiment of the disclosure.

FIG. 7 is a sample application of the Input Assistant Pad of FIG. 2 according to one embodiment of the disclosure.

### DETAILED DESCRIPTION

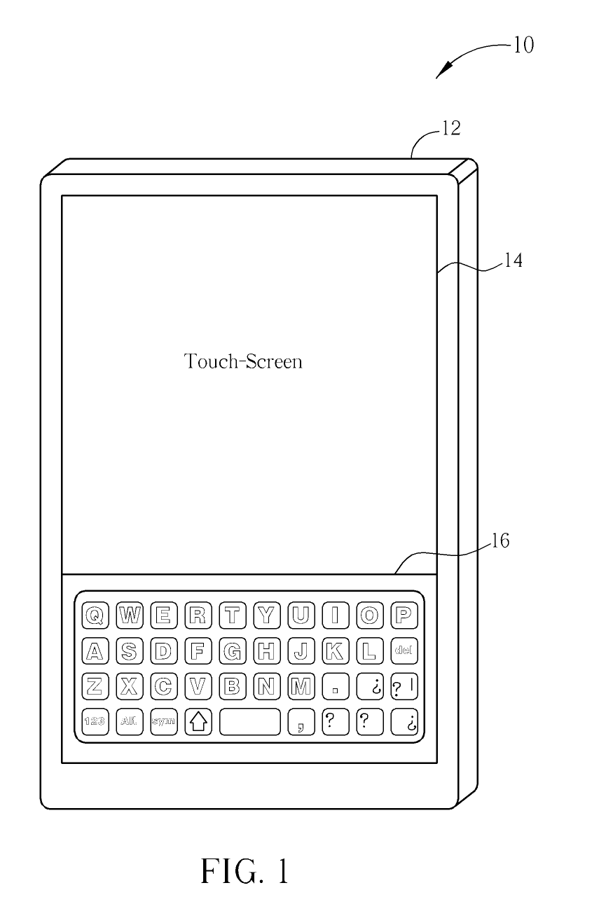

Please refer to FIG. 1, which is a functional block diagram of an electronic device 10 that utilizes a touch-screen for receiving user input. The electronic device 10 comprises a housing 12 and a touch-screen 14, on which is displayed a virtual keyboard 16, software generated, by the electronic device to receive user input. The electronic device 10 may optionally further comprise a transparent or semi-transparent, normally plastic protective layer (not shown) that is applied to cover and protect the outer surface of the touch-screen 14. In this disclosure including claims, for electronic devices that utilize such a protective layer, the protective layer is considered to be an integral part of the physical structure of the touch-screen 14.

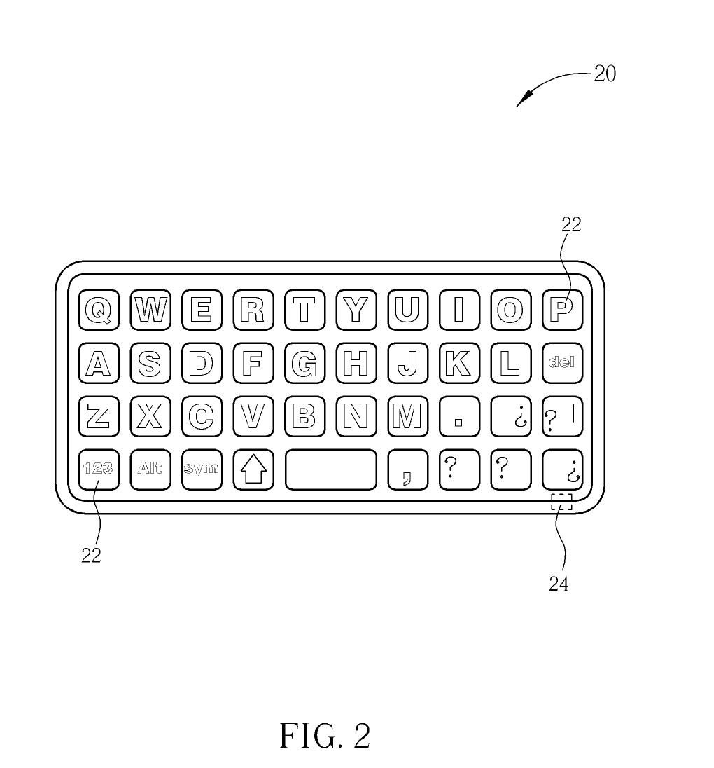

FIG. 2 is a block diagram of an Input Assistant Pad 20 according to an embodiment of the disclosure. The Input Assistant Pad 20 may comprise one or more layers of flexible material, inter alia, such as rubber or plastic and includes a plurality of keys 22 arranged keyboard-like on its larger surfaces. The flexible material in some embodiments may be transparent, in other embodiments semi-transparent or translucent, and opaque in others (or a combination thereof). The specific number and arrangement of keys 22 may vary between embodiments and is determined according to the character set and/or type of keyboard desired, for examples, an English language keyboard is normally different than one for inputting the Chinese language, and/or a QWERTY keyboard normally requires more keys than an ITU-9 keyboard requires.

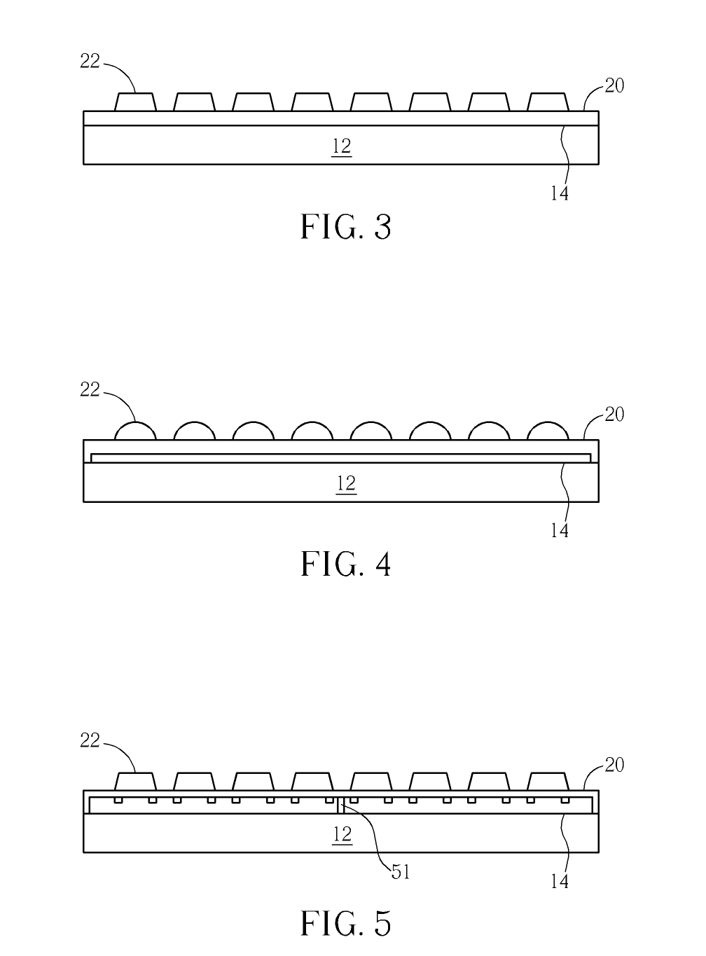

The shapes and sizes of the keys 22 also may vary between embodiments or within a single embodiment according to design considerations. For example the key 22 representing a space bar may be larger than the key 22 representing a letter, such as “A”. However, each key 22 may comprise a bump or series of bumps, one or more ridges, one or more depressions, or another physical structure or combination of physical structures formed on one or both sides of the Input Assistant Pad 20 that allow a user using the sense of touch alone to distinguish if a specific area of the Input Assistant Pad 20 is a key 22 or another area of the Input Assistant Pad 20 that is not a key 22, such as areas between keys 22 and/or at peripheral edges of the Input Assistant Pad 20. Such configurations free a user from the conventional necessity of looking at the touch-screen while entering text as well as increasing typing accuracy afforded by physically confirming key 22 location before the key 22 is pressed. In some embodiments, the specific physical structure of keys 22 may be different for a specific key 22 or keys 22, or in other embodiments, different for each key 22, allowing accurate selection of a specific key 22 by touch alone. Some non-limiting examples of such keys 22 are shown in the end views of the electronic device 10 in FIG. 3, FIG. 4, and FIG. 5. In some embodiments where the Input Assistant Pad 20 is transparent or semi-transparent, key indicators displayed on the underlying virtual keyboard 16 may be at least partially displayed to the user. In other embodiments according to design requirements, the keys 22 of the Input Assistant Pad 20 may additionally comprise visual markings such as numerical, alphabetical, or special phonetic characters indicating which character or function is to be associated with that particular key 22.

FIG. 3 further illustrates an end view of the electronic device 10 as seen from the end of the electronic device 10 nearest the Input Assistant Pad 20. As can be seen in FIG. 3, some embodiments of the disclosure allow a larger surface of the Input Assistant Pad 20 to contact the touch-screen 14 directly. FIG. 4 illustrates the same end view of other embodiments of the disclosure where when a key 22 is not being pressed by the user, the Input Assistant Pad 20 does not directly contact the touch-screen 14, but is elevated over the surface of the touch-screen 14 (and protective layer if present), avoiding constant contact between the Input Assistant Pad 20 and the touch-screen 14. Additional embodiments depict a sort of combination of the Input Assistant Pad 20 of FIG. 3 and FIG. 4, where the main body of the Input Assistant Pad 20 does not contact the touch screen 14; however one or more separation supports 51 contact both the touch-screen 14 and the Input Assistant Pad 20 as shown in FIG. 5.

In a prior art physical hardware keyboard, a clock signal and bi-directional communication between the keyboard and a computer are necessary, requiring the physical hardware keyboard to comprise a processor, circuitry, a character map, and a plurality of switches or one kind or another. When a user presses a key of a prior art keyboard, one of the plurality of switches is opened (or closed if open is the default), the processor determines from the character map which character the opened circuit corresponds to, and when allowed to by the computer, transmits the relevant information to the computer for further processing.

The Input Assistant Pad 20 does not require switches or bi-directional communication to function and sensing of clicking of the key 22 is not necessary. Instead the shapes, sizes, and locations of the keys 22 modify a first touch (that of the user's finger to the key 22) into a different, second touch (that the underside of the key 22 applies to the touch-screen 14) generating an appropriate touch event interpreted correspondingly by software within by the electronic device 10. As illustrated in FIG. 3, FIG. 4, and FIG. 5, because the top of the key 22 (the portion of a key 22 touched by the user) may be of a different size, shape, and/or location than the bottom of the key 22 (the portion of key 22 that makes contact with the touch-screen 14), the first touch and the second touch may not be the same thing, allowing interpretation of touch events generated by the Input Assistant Pad 20 to be determined by software, rather than only by physical location on the underlying virtual keyboard 16.

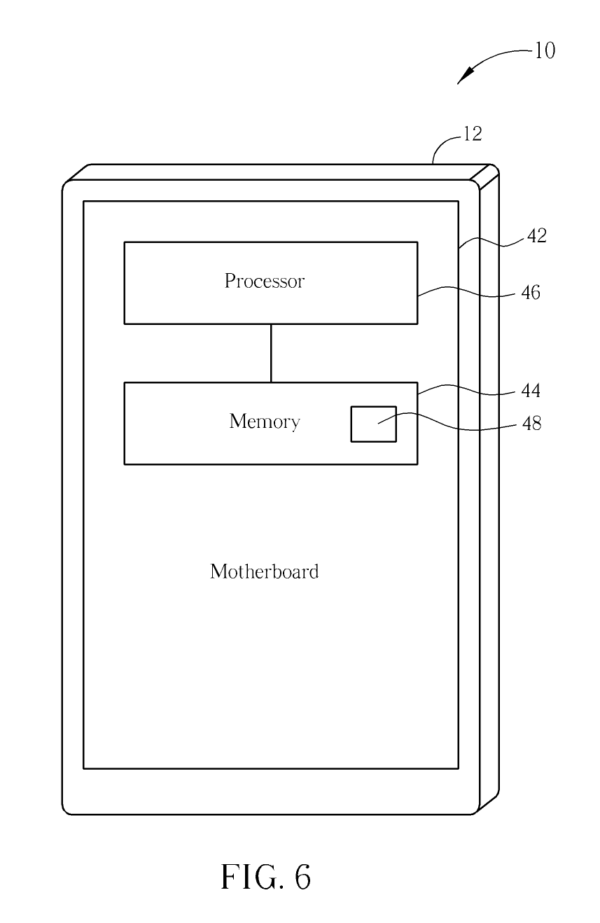

Please refer now to FIG. 6, which is a partial functional block diagram of inside the electronic device 10 that utilizes a touch-screen 14 for receiving user input according to an embodiment of the disclosure. The electronic device 10 may further include a PCB (printed circuit board) or other kind of motherboard 42 normally fixed inside of the electronic device 10. The motherboard 42 provides support for, and connections between, electrical components (including the processor 46) that may be used for implementing embodiments of the disclosure, as well as any connections between the electrical components, between the electrical components and the touch-screen 14, and the electrical components and any other input or output devices, such as buttons, antennas, or speakers.

The electrical components also include a memory 44. The memory 44 stores program code 48, which when executed by the processor 46, implement the interpretation of the generated touch event so as to mimic the desired version of an event driven keyboard. The software 48 may be a form of Input Method Editor (IME) software. Various embodiments include software 48 that further permits calibration (determination of location) of the Input Assistant Pad 20 relative to the touch-screen 14, adjustment of spacing between keys 22 which may or may not correspond to spacing between keys of the underlying virtual keyboard 16, compensation for unintentional contact, such as ignoring touch signals generated by the supports 51 contacting the touch-screen, adjustment of the underlying virtual keyboard 16 location, and/or functionality, key spacing, or type of virtual keyboard 16 displayed according to the type of Input Assistant Pad 20 being utilized, or even may remove display of the virtual keyboard 16 from the electronic device 10 when the keys 22 of the Input Assistant Pad 20 comprise the visual markings indicating which character or function is to be associated with that particular key 22.

Further modifications to any and all embodiments may include utilizing additional materials in the Input Assistant Pad 20 to aid in capacitance, perhaps metal, especially when applied to a capacitive sensing type touch-screen. Some embodiments only include the additional materials in specific locations of the Input Assistant Pad 20, such as under the keys 22 but do not include the additional materials in non-key 22 areas to prevent unintended input to the touch-screen 14. As shown in FIG. 2, A Radio Frequency Identification (RFID) chip 24 or Near Field Communication (NFC) chip 24 may be included in the Input Assistant Pad 20 to enable the electronic device 10 to determine presence or absence of a particular type of the Input Assistant Pad 20, and modify interpretations of generated touch events accordingly. Some embodiments of the Input Assistant Pad 20 may allow a physical connection between the Input Assistant Pad 20 and the housing 12 to inform the electronic device 10 to modify interpretations of generated touch events suitably according to the particular type of the connected Input Assistant Pad 20.

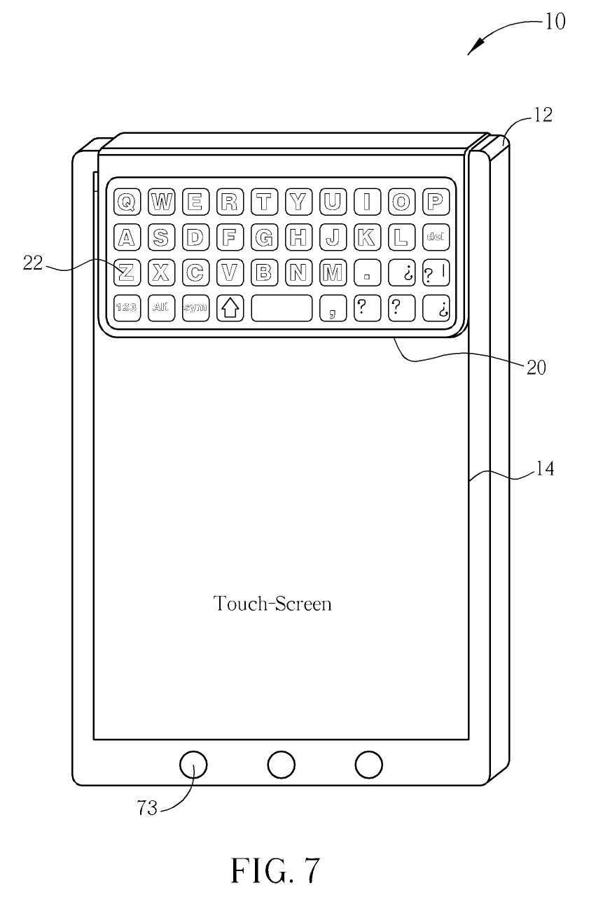

The Input Assistant Pad 20 may be connected to a portion of the housing 12, or in the alternative to a separate casing, perhaps protective or decorative, at least partially surrounding the housing 12. In this disclosure, terminologies of the housing 12 and the separate casing as described here are to be considered interchangeable, such that if the electronic device 10 utilizes a separate casing, the separate casing is to be considered a part of the physical structure of the housing 12. The Input Assistant Pad 20 may slide out of the housing 12 or merely partially disconnect from the housing 12 so that it can wrap around to cover the desired location on the touch-screen 14. One non-limiting example embodiment is shown in FIG. 7, where the Input Assistant Pad 20 is connected to the back of the housing 12. In this example, the housing 12 of the electronic device 10 comprises one or more buttons 73 which should remain accessible to the user at all times. In this situation, the Input Assistant Pad 20 may wrap around a side or end of the electronic device 10 that lacks such buttons 73 during text entry. In FIG. 7, the Input Assistant Pad 20 wraps around the top end of the housing 12 as shown. As the virtual keyboard 16 is normally displayed at the opposite end of the electronic device 10, the Input Assistant Pad 20 and virtual keyboard 16 may not occupy the same portion of the touch-screen 14. Thus the software 48, according to design considerations, may relocate the underlying virtual keyboard 16 to substantially match the location of the Input Assistant Pad 20, or alternatively, especially if the Input Assistant Pad 20 includes visual markings indicating which character or function is to be associated with that particular key 22, the software 48 may cause the underlying virtual keyboard 16 not to be displayed at all on the touch-screen 14.

The Input Assistant Pad allows emulation of the hardware keyboard typing experience on a large (preferably 3 inch diagonal or greater) touch-screen device, as a way to overcome the lack of physical feedback when typing on a virtualized on-screen keyboard. The Input Assistant Pad solves this problem by adding an assisting physical layer on top of the touch-screen, to provide the physical guidance and feedback to fingers. The Input Assistant Pad may have physically raised (or lowered or altered) areas to simulate the touch and feel of physical key buttons. Layout of these areas may mimic the common layout of QWERTY or ITU-9 keyboards. Physical dimension and supporting mechanisms of the Input Assistant Pad may be designed to fit a specific touch-screen device to provide a firm positioning, as well as possibly combining with the housings to provide a protective function to touch-screen devices. The Input Assistant Pad enables quick text entry on a touch-screen device without the necessity of continuously staring at the touch-screen. Once a user is familiarized with the layout of the Input Assistant Pad, typing by touch alone is possible on touch-screen devices. Additionally, because the Input Assistant Pad give physical guidance in key locating accuracy before a key is pressed, the number of errors entered will be reduced, substantially reducing or even eliminating the costs, power consumption, need for touch-screen are to show corrective options, and other complications required to autocorrect the input base on vocabulary heuristics.

Those skilled in the art will readily observe that numerous modifications and alterations of the device and method may be made while retaining the teachings of the invention.

What is claimed is:

1. An electronic device comprising:
a touch-screen for receiving user input;
a processor coupled to the touch-screen;
a removable flexible material contacting the touch-screen, the flexible material having a plurality of key structures that modify a first touch applied by a user to a key structure of the plurality of key structures into a different, second touch applied to the touch-screen to generate a touch event; and
a memory coupled to the processor and comprising computer code which when executed by the processor interprets the touch event generated by the second touch according to the first touch.

2. The electronic device of claim 1 wherein the computer code further comprises calibration code for calibrating location of the flexible material in relation to the touch-screen.

3. The electronic device of claim 1 wherein the flexible material further comprises a Radio Frequency Identification chip or a Near Field Communications chip to identify the flexible material to the electronic device.

4. The electronic device of claim 1 wherein a key structure of the plurality of key structures comprises a bump or series of bumps, one or more ridges, and/or one or more depressions formed on one or both sides of the flexible material that allow the user using the sense of touch alone to distinguish if a specific area of the flexible material is the key structure or another area of the flexible material that is not the key structure.

5. The electronic device of claim 4 wherein the area of the flexible material that is not the key structure separates the specific area of the flexible material that is the key structure from contact with the touch-screen when a the key structure is not being pressed by the user.

6. The electronic device of claim 4 wherein the plurality of key structures formed such that at least two of the key structures have different physical structures allowing accurate selection of a specific key structure by touch alone.

7. The electronic device of claim 4 wherein the key structure comprises a visual marking indicating which character or function is to be associated with that particular key.

8. The electronic device of claim 7 wherein the visual marking is numerical, alphabetical, or a special phonetic character.

9. The electronic device of claim 1 wherein the processor further generates a virtual keyboard on the touch-screen having different spacings between keys of the virtual keyboard and spacings of the key structures of the flexible material.

10. The electronic device of claim 1 wherein the key structures further comprise a conductive material.

11. The electronic device of claim 1 wherein the key structures extend from two sides of the flexible material and a physical structure of the key structure on one side of the flexible material is different than a physical structure of the key structure on the other side of the flexible material.

12. The electronic device of claim 1 wherein the flexible material is transparent or semi-transparent.
